(19) United States
(12) Patent Application Publication
(10) Pub. No.: US 2004/0013783 A1
(43) Pub. Date: Jan. 22, 2004

(54) Jellied food preparation

(76) Inventor: Scott Alan Miller, Bogalusa, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 10/196,660

(22) Filed: Jul. 16, 2002

(51) Int. Cl. A23L 1/05

(52) U.S. Cl. 426/575

(57) ABSTRACT

A jellying food product contains agar-agar as a jellying agent. Agar-agar is dissolved in water, boiled, cooled and mixed with alcohol to prepare a gelatinous food product. A sweetener and a flavoring agent are added depending on the taste of the consumer.

### BACKGROUND OF THE INVENTION

This invention relates to a gelatinous jelling product and a method of preparing thereof. More particularly, this invention relates to a gelatinized product containing a jelling agent, water and alcohol.

Jellied food preparations and jellied products have been widely used in the food preparation technology. The main ingredient in these preparations is usually a jelling agent, such as pectin, locust bean gum, carrageenan, and others. In order to make a jelly, the jelling agents are usually dissolved in hot liquid and then rapidly cooled to solidify the product. It is essential that the solid contents of the food product be thoroughly dissolved in the liquid before cooling the product. If the solids do not dissolve or the percentage of the solids is too high, the product does not properly gelatinize.

Recently, a certain type of food preparation known as “Jell-O Shots” has been developed and used as a form of consumption of alcohol. In such products, the alcohol content is relatively high, sometimes reaching 50% of water, which is used for dissolving the jelling agent. Typically, the “Jell-O Shot” is prepared with prepackaged flavored Jell-O®, first mixing it with boiling water, then adding the alcoholic beverage and freezing the resultant mixture. The flavor, as well as the color variations of the conventional “Jell O Shots” depend greatly on the boxed gelatin products available on the market.

The tests have shown that the “Jell O Shots” prepared according to conventional methods oftentimes produce an unreliable result. In some cases, the final product becomes clouded, loses the desired transparency, and becomes unattractive. In other tests, it was demonstrated that alcohol and gelatin mixtures precipitate in the water solution, also resulting in an unattractive product.

The present invention contemplates elimination of drawbacks associated with the prior art and provision of a method for making jellied food products that retain sensory characteristics even in a non-refrigerated state.

### SUMMARY OF THE INVENTION

It is, therefore, an object of the present invention to provide a jellied food product containing water, alcohol and a flavoring agent.

It is another object of the present invention to provide a method of making a jellied product that retains sensory characteristics in a non-refrigerated state.

It is a further object of the present invention to provide a method of making a jellied food product that is easy to follow at home, as well as in a restaurant environment.

These and other objects of the present invention are achieved through a provision of a jellied food product and a method of preparing thereof that does not require refrigeration and has an extended shelf life in comparison with conventional jellying food products. The jellied food product has a relatively high water content, between about 61.6 to 79.3 percent. The jellying agent is agar-agar, readily available as Agar GS900. The amount of the dry powdered jellying agent present in the product is about 0.1 to about 0.7 percent.

The product of the present invention contains about 10 to 20 percent alcohol and a flavoring agent. Alcohol is preferably 190 proof grain alcohol, and the flavoring agent can be a fruit-flavored or artificially-flavored agent. The product also contains a sweetener, such as sugar, sucrose, glucose, fructose, etc.

In preparing the jellied product of the present invention, the operator first allows agar-agar to dissolve in water and then adds the sweetener. The sweetened mixture is brought to a boil to allow the sweetener and the jellying agent to fully dissolve. The boiled mixture is then allowed to cool to a temperature below 61.6 degrees Celsius, after which time alcohol is added together with a flavoring and a stabilizing agent, such as for instance potassium sorbate, sodium benzonate or other food stabilizing agent.

The resultant food product has clear color, with no precipitated solids and retains the sensory characteristics for an extended period of time without refrigeration.

### DETAILED DESCRIPTION OF THE PREFERRED EMBODIMENT

The invention provides for a jelling product and a method of making thereof using water, as a wetting agent, a jelling agent, flavoring and alcohol.

The jelling product, according to the present invention, contains Agar-Agar as a jelling agent. Agar-Agar is a colloidal substance that is obtained from certain types of seaweed. It is used in the food industry as a stabilizer, solidifying agent in meat, preserves, jelly, pastry, and dairy products. It is also used in custards, ice cream, chocolates, candies, cosmetics, breads, and other food products. One of the beneficial characteristics of Agar-Agar is that it solidifies at 37-40 degrees centigrade without the use of refrigeration. It maintains a gelatin-like state at up to 70-80 degrees centigrade. Agar-Agar has better jelling characteristics than other available jelling agents when alcohol is added, such as for instance carrageenan, commercially available gelatin powder and the like. In fact, the tests demonstrated that carrageenan does not produce a stable product when alcohol is added.

Agar-Agar is readily dissolvable in boiling water (100 degrees Celsius) and does not dissolve at temperatures below boiling. Agar-Agar is known to retain water when it reaches a gelatin-like state, which allows to retain the sensory characteristics of the jelling product similar to fresh condition. It has been reported that Agar-Agar is 8-16 times stronger than other types of gels and is relatively inexpensive.

Agar-Agar is readily available on the market from a variety of sources, one of the manufacturers being P. L. Thomas and Company, Inc. of Morristown, N.J. Agar-Agar is available in a crystalline powder form of white to pale yellow color; it has no odor.

The sweetening agent used in the preparation of the product of the present invention maybe conventional sugar, for instance sucrose, glucose, or fructose in a powder form or in an aqueous solution thereof. Sugar alcohol may also be used, for instance Sorbitol, Lactisol, or Sylitol.

The gelling product of the present invention also contains a flavoring agent, which can be any flavoring, with color or without color added. Some of the tested flavoring agents were grape and orange flavorings, which are readily available on the market. Of course, other flavoring agents can be used, depending on the demand and availability to the user.

The alcohol used in the tests of preparing the food product of the present invention is a conventional alcohol, for instance 190 degrees proof whole grain alcohol, which is readily available from a variety of sources. Of course, other alcoholic liquids may be used, if desired. The present invention may also contain a stabilizing agent, for instance potassium sorbate, sodium benzonate and other food preservatives.

In the preferred embodiment, the present invention when war ingredients constitute 100 ml, contains between about 0.1 to 0.7 grams of Agar GS 900 (0.1 to 0.7%), between about 10 to 17 grams of sugar (10-17%), 0.6-0.8 ml of flavoring agent (0.6-0.8%), 3 drops of potassium sorbate and between about 10 to 20 milliliters (10-20%) of alcohol mixed with water.

The flavoring agent or agents used in the present invention can be strawberry, watermelon, orange, etc. The flavoring agent may contain artificial or natural flavor and a coloring agent if desired. One of the interesting examples of the gelling product produced in accordance with the present invention was achieved using a flavor identified as “orange supreme” available from CFF, Carmi Flavor and Fragrance Company, Inc. of City of Commerce, California.

The method of making the jelling product of the present invention is relatively straightforward: the gelling agent, Agar-Agar GS 900 is allowed to dissolve in water at room temperature for about 10-15 minutes. Then sweetener is then added and the sweetened mixture is brought to a boil in order to dissolve the sweetener and Agar-Agar together. Then, the flavoring agent is added together with the stabilizer, such as potassium sorbate. The mixture is then allowed to slightly cool to a temperature of below 62 degrees Celsius. It was determined that the temperature of below 62 degrees Celsius produces superior results. This temperature appears to be below the evaporation point for alcohol and preserves alcohol in the desired condition.

The next step involves addition of alcohol and thoroughly mixing of the resultant mixture. The product is allowed to rest, causing the jellying agent to jellify and form a food product with alcohol and the desired flavor.

### EXAMPLE #1

The raw materials to make up about 100 ml of the total amount and containing 61.6 milliliters of water, 0.7 grams of Agar-Agar were allowed to stand without agitation at room temperature for 10 minutes. 17 grams of sugar were then added and the mixture was brought to a boil until the sugar and the Agar-Agar dissolved. The container with the boiled mixture was then removed from the heat source, and 0.8 ml of a flavoring agent, in this case grape flavoring, were added to the mixture. Then a few drops of potassium sorbate were added and the mixture was allowed to cool to about 61.6 degrees Celsius. The 190 proof wheat grain alcohol in the amount of 20 milliliters was then added to the mixture and the product allowed to jellify, which occurred within 2-3 minutes. The resultant product was pleasing in appearance, transparent with defined grape color. The product retained sensory characteristics of a fresh product with no refrigeration and was stable after several days of storage.

### EXAMPLE #2

The raw materials to make up about 100 ml of the total amount and containing 79.3 milliliters of water was mixed with 0.1 grams of Agar-Agar GS 900 and allowed to stand for 15 minutes at room temperature. 10 grams of sugar was then added to the Agar-Agar solution and the mixture was brought to a boil. Once the solids were dissolved in water, the mixture was taken off the heat source and 0.6 ml of “orange supreme” flavor was added along with 3 drops of potassium sorbate. The mixture was then allowed to cool below 62 degrees Fahrenheit, in this test to about 57 degrees Celsius, and then 10 ml of 190% proof alcohol were added to the mixture. The mixture was allowed to jellify, which occurred in 3 minutes. The resultant food product was clear in appearance, retained sensory characteristics of a fresh product after a shelf life of several days and required no refrigeration.

It is envisioned that the gelling product of the present invention can be manufactured by heating of water and Agar-Agar on a conventional stove or in a microwave oven. In the preferred embodiment, the product contained from between 61.6 to about 79.3% of water, between about 0.1 to about 0.7% of a jelling agent, between about 10 to about 17% of a sweetening agent, between about 0.6 to about 0.8% of a flavoring agent, and between about 10 to about 20% alcohol.

It is envisioned that an increase in the percentage of water will produce a drinkable gelatinized drink containing alcohol.

Many other changes and modifications may be made in the method and formula of the product in accordance with the present invention. I therefore pray that my rights to the present invention be limited only by the scope of the appended claims.

I claim:

1. A jellied food product, comprising water, alcohol, a jellying agent and sweetener, and wherein said jellying agent is agar-agar.

2. The product of claim 1, wherein said product further comprises a flavoring agent.

3. The product of claim 1, wherein said product further comprises a stabilizing agent.

4. The product of claim 3, wherein said stabilizing agent is potassium sorbate.

5. The product of claim 1, wherein alcohol content of said product is between about 10 percent to about 20 percent calculated as percentage of the food product.

6. The product of claim 1, wherein said alcohol is 190 degree proof grain alcohol.

7. The product of claim 1, comprising between about 61.6 percent to about 79.3 percent of water calculated as percentage of the food product.

8. The product of claim 1, comprising between about 0.1 percent to about 0.7 percent of the jellying agent calculated as percentage of the food product.

9. The product of claim 1, comprising between about 10 percent to about 17 percent of the sweetening agent, calculated as percentage of the food product.

10. The product of claim 1, comprising between about 0.6 percent to about 0.8 percent of the flavoring agent, calculated as percentage of the food product.

11. The product of claim 1, wherein said sweetener is sugar.

12. A jellied food product, comprising at least 61.6 percent of water, at least 0.1 of a jellying agent, at least 10 percent of a sweetener, calculated as percentage of the food product.

13. The product of claim 12, wherein said product comprises between about 761.6 percent to about 79.3 percent of water, between about 0.1 percent to about 0.7 percent of jellying agent, and between about 10 percent to about 17 percent of sweetener, calculated as percentage of the total product.

14. The product of claim 12, further comprising a stabilizing agent.

15. The product of claim 14, wherein said stabilizing agent is potassium sorbate.

16. The product of claim 12, further comprising between about 0.6 percent to about 0.8 percent of a flavoring agent, calculated as percentage of total product.

17. The product of claim 12, wherein said jellying agent is agar-agar.

18. A method of preparing a jellied food product, comprising the steps of:
mixing a pre-determined amount of a jellying agent with water;
adding a pre-determined amount of a sweetening agent and bringing the sweetened mixture to a boil;
allowing the mixture to cool to a predetermined temperature; adding alcohol; and
allowing the resultant mixture to jellify.

19. The method of claim 18, further comprising the step of storing jellied food product without refrigeration.

20. The method of claim 18, further comprising the step of adding a food flavoring before adding alcohol.

21. The method of claim 18, further comprising the step of adding a stabilizing agent before adding alcohol.

22. The method of claim 21, wherein said stabilizing agent is potassium sorbate.

23. The method of claim 18, wherein the boiled mixture is allowed to cool to a temperature below 61.6 degrees Celsius.

24. The method of claim 18, wherein said jellied food product has an alcohol content of about 10 to 20 percent.

25. The method of claim 18, wherein said jellied mixture has water content of between about 61.6 to 79.3 percent.

26. The method of claim 18, wherein said jellied mixture has added sweetener of about 10 to 17 percent.

27. The method of claim 20, wherein said jellied mixture has flavoring content of about 0.6 to 0.8 percent.
